(19) United States
(12) Patent Application Publication
(10) Pub. No.: US 2013/0031179 A1
(43) Pub. Date: Jan. 31, 2013

(54) SOCIAL-NETWORK METHOD FOR ANTICIPATING EPIDEMICS AND TRENDS

(71) Applicants: Nicholas A. Christakis, Cambridge, MA (US); James H. Fowler, San Diego, CA (US)

(72) Inventors: Nicholas A. Christakis, Cambridge, MA (US); James H. Fowler, San Diego, CA (US)

(73) Assignee: PRESIDENT AND FELLOWS OF HARVARD COLLEGE, Cambridge, MA (US)

(21) Appl. No.: 13/639,123

(22) PCT Filed: Apr. 18, 2011
(86) PCT No.: PCT/US11/32852

§ 371 Date: Oct. 3, 2012

Related U.S. Application Data
(60) Provisional application No. 61/324,979, filed on Apr. 16, 2010.
(60) Provisional application No. 61/366,639, filed on Jul. 22, 2010.

(51) Int. Cl. G06F 15/16

(52) U.S. Cl. 709/204

(57) ABSTRACT

In order to anticipate an epidemic or adoption of a trend, individuals are randomly selected from a population and friends of the selected individuals are determined. These friends are then designated as sensors and monitored to predict or anticipate the adoption of a trend or the spread of a contagious outbreak. In one embodiment, online searches performed by these friends are monitored for the use of selected search queries to predict or anticipate the adoption of a trend or the spread of a contagious outbreak.

### TECHNICAL FIELD

This invention relates to methods for monitoring the spread of disease and the prediction of epidemics and trends.

### BACKGROUND ART

Advance warning of epidemics in defined locations or populations could facilitate an optimal response to preventing or at least containing them. If such an advance warning was available, prior work has suggested that knowledge of network structures, such as human social networks, can be exploited to respond to epidemics by administering prophylactic interventions, for example, by preferentially vaccinating central individuals in networks, thus enhancing the population-level efficacy of the intervention.

Ideally, current methods for the detection of contagious outbreaks give contemporaneous information about the course of an epidemic, though, more typically, they only detect that an epidemic has occurred several weeks after the actual occurrence.

It is known that knowledge of network structures can be exploited to detect and monitor trends. For example, the optimal placement of sensors in a network of water pumping stations could identify contamination earlier or the monitoring of carefully chosen blogs within the blogosphere could detect new information sooner.

Human social networks can also be used to identify individuals who are at high risk of contracting a disease. For example, a contagion that stochastically infects some individuals and then spreads from person to person in a human social network will tend, on average, to reach centrally-located individuals more quickly because they are a smaller number of steps (degrees of separation) away from the average individual in the network than those on the periphery—a tendency that is supported by computer simulations. Therefore, during a contagious outbreak, individuals at the center of a social network are likely to be infected sooner than random members of the population. Hence, the careful collection of information from the central individuals in a human social network could be used to monitor contagious outbreaks.

However, determining or mapping a whole human social network to identify particular individuals from whom to collect information is costly, time-consuming, and often impossible, especially for large networks.

In 2008, the search engine company, Google, tried an alternative approach using search engine results. This approach is based on the fact that millions of users around the world search for health information online using a search engine, such as that developed by Google. By examining the queries that individuals submitted to search engines to perform these searches and comparing the number of such queries with the infected individual numbers obtained from traditional influenza surveillance systems, it was found that there was a close relationship between the number of people who search for influenza-related topics and the number of people who actually have influenza symptoms. In particular, the number of occurrences of particular influenza-related search queries at any one time and originating from different locations can provide an estimate of the numbers of infected individuals in different countries and regions around the world. This technique is described in more detail in an article entitled “Detecting Influenza Epidemics Using Search Engine Query Data”, Ginsberg J, Mohebbi M H, Patel R S, Brammer L, Smolinski M S and Brilliant L, Nature, v. 457 pp 1012-1014 (2009). Since the search results are essentially immediately available, this technique can provide estimates that precede estimates produced the traditional systems by several weeks.

However, it would be advantageous to provide results even before those available with search engine techniques.

### DISCLOSURE OF INVENTION

In accordance with the principles of the invention, individuals are randomly selected from a population and friends of the selected individuals are determined. These friends could be friends nominated by the selected individuals, spouses, siblings or any other persons with a social connection to the selected individuals, which are referred to collectively below as “friends”. The friends are then designated as sensors and monitored to predict or anticipate the adoption of a trend or the spread of a contagious outbreak.

In one embodiment, friends are determined by asking each selected individual to nominate at least one friend and selecting as friends individuals from the population who were nominated as a friend by at least one selected individual.

In another embodiment, friends are determined by asking each selected individual to nominate at least one friend and selecting as friends individuals from the population who were nominated as a friend by a plurality of selected individuals.

In still another embodiment, friends are determined by monitoring communications of each selected individual with other people and determining as friends people with whom each selected individual has had a predetermined number of communications.

In yet another embodiment, sensors are monitored with external means for evidence of infection or the adoption of a trend.

In another embodiment, each sensor self reports an infection or the adoption of a trend.

In still another embodiment, the search queries of sensors are monitored for predetermined words and phrases.

In yet another embodiment, both the selected individuals and the friends are monitored and the results of the monitoring of each group are compared to predict or anticipate the adoption of a trend or the spread of a contagious outbreak.

### BRIEF DESCRIPTION OF DRAWINGS

FIG. 1A is a plot of cumulative incidence of contagion versus time that illustrates a shift in time of the curve for central individuals of a human social network.

FIG. 1B is a plot of the daily incidence of contagion versus time that illustrates a shift in time of the curve for central individuals of a human social network.

FIG. 2 is a flowchart showing the steps in an illustrative method for predicting the spread of infection or the adoption of a trend in accordance with the principles of the invention.

FIG. 3 is a block schematic diagram illustrating the method shown in FIG. 2.

FIG. 4A is a plot of a nonparametric maximum likelihood estimate (NPMLE) of cumulative influenza incidence versus time for a “friend” sample and a “random” sample of individuals in a population.

FIG. 4B is a plot of the predicted daily incidence of influenza infection versus time from a nonlinear least squares fit of the data to a logistic distribution function.

FIGS. 5A-5F are social network diagrams of a network of 714 people having six panels, with each figure corresponding to a particular day in the study and illustrating the spread of influenza in the population.

FIG. 6 shows three bar charts illustrating the effect on early warning as influenced by network properties, such as in-degree centrality, betweenness centrality and transitivity.

FIG. 7 is a block schematic diagram of an alternative method predicting the spread of infection or the adoption of a trend in accordance with the principles of the invention.

### BEST MODE FOR CARRYING OUT THE INVENTION

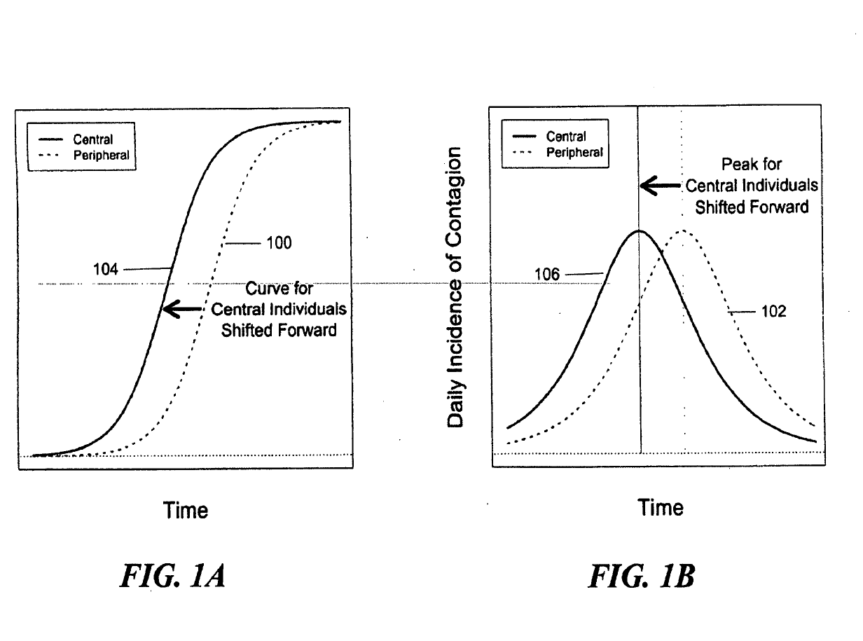

A contagious process passes through two phases, one in which the number of infected individuals exponentially increases as the contagion spreads, and one in which incidence decreases as susceptible a cumulative logistic function such as:

$${P}_{it} = {λ ( 1 + {e}^{\frac{- ( t + α + b {X}_{it} )}{σ}} )}^{- 1} \qquad ( 1 )$$

where Pᵢₜ is the probability subject i has the influenza on or before day t; t+α+bXᵢₜ is a function that determines the location of peak risk to subject i on day t that includes a constant α, a vector of coefficients b, and a matrix of independent variables Xᵢₜ; α is a constant scale factor that provides an estimate of the standard deviation in days of the time course of the epidemic; and 0≦λ≦1 is a constant indicating the maximum cumulative risk. This process leads to a well-known “S-shaped” adoption or epidemic curve 100 shown in FIG. 1A which plots the cumulative incidence of contagion on the vertical axis against time on the horizontal axis.

A second logistic curve 102, shown in FIG. 1B, is the peak infection curve that plots the daily incidence of contagion versus time and which also increases as the contagion spreads, and decreases as susceptible individuals become increasingly scarce. The daily incidence is the derivative of the cumulative logistic function:

$${p}_{t} = \frac{λ {e}^{\frac{- ( t + α )}{σ}}}{σ ( 1 + {e}^{\frac{- ( t + α )}{σ}} )} \qquad ( 2 )$$

Central individuals lie on more paths in a human social network compared to peripheral individuals and are therefore more likely to be infected early by a contagion that randomly infects some individuals and then spreads from person to person within the network. In accordance with the principles of the invention, this shifts the S-shaped logistic cumulative incidence function forward in time for central individuals compared to peripheral individuals as shown by curve 104 in FIG. 1A. The process also shifts the peak infection rate forward as illustrated by curve 106 in FIG. 1B. Therefore, by monitoring the central individuals, the increase in contagion or the peak infection timing in the general population can be anticipated or predicted.

In order to identify the centrally-located individuals, the entire network is not mapped. Rather, individuals are randomly selected from a population and friends of the selected individuals are determined. These friends are then designated as sensors and monitored to predict or anticipate the adoption of a trend or the spread of a contagious outbreak. This strategy exploits a known property of human social networks: on average, the friends of randomly selected people possess more links (have higher degree) and are also more central to the network than the initial, randomly selected people who named them.

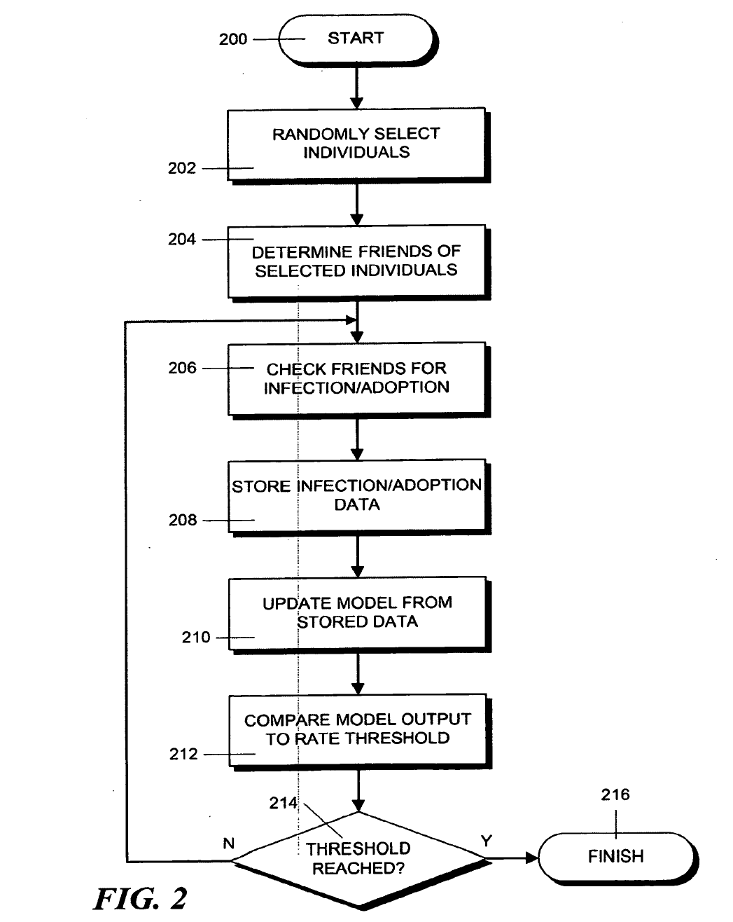

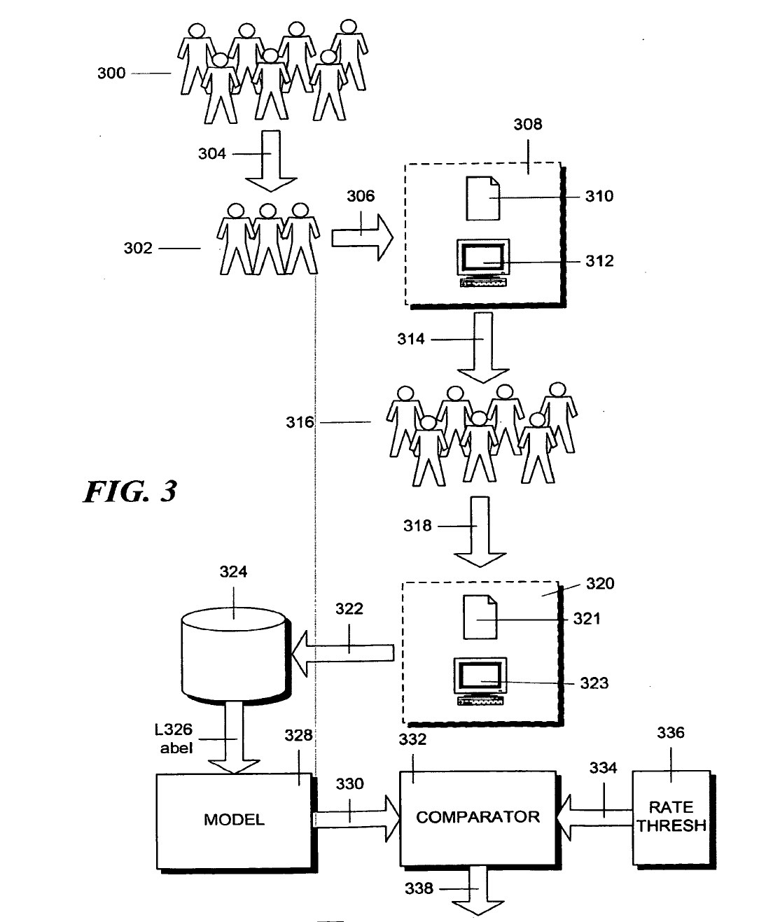

The process is shown in FIGS. 2 and 3. This process starts in step 200 and proceeds to step 202 where a set of individuals 302 are randomly selected from a population to be studied as schematically indicated by arrow 304. The step could be performed, for example, by assigning each individual in the population a number and then randomly selecting a plurality of numbers, thereby selecting the corresponding individuals.

Then, in step 204, friends 316 of the selected individuals 302 are determined as indicated by arrows 306 and 314 and box 308, which schematically illustrate alternative methods of determining friends. One method, schematically illustrated by paper 310, is to conduct a survey of the selected individuals 302 asking them to nominate up to a predetermined number of people that they consider as “friends.” This survey could be conducted using paper forms or online. A possible alternative to the friendship nomination procedure would be to rely on the selected individual's self-reported popularity or self-reported counts of numbers of friends in order to identify a friend group. In addition, there could be subtleties in how friends are nominated. The selected individual might be surveyed and asked questions such as “Is this someone you spend free time with?” or “Is this someone you discuss personal matters with?” or “Is this someone you could borrow unsecured money from?” in order to determined whether that person is a friend and the closeness of the friendship. Further, only selected friends might be chosen or the nominated friends might be weighted, for example based on the results of the survey.

Another possible alternative to the friendship nomination procedure, schematically illustrated as the computer 312, would be to monitor communications, such as emails or telephone conversations between the selected individuals and other members of the population. When the number of these communications between a selected person and another person exceeds a threshold, that other person would be deemed a friend. Other alternatives for passively determining friends in situations where the appropriate information is available include monitoring the sharing of patients between doctors and monitoring the giving of gifts between the selected individuals and others

In step 206, the individuals in the friend group are checked for an infection or the adoption of a trend as indicated by arrow 318 and box 320. As with the selection of friends, this check could be performed in several different ways. For example, in the case of an infection, as indicated schematically by paper 321, this check could be a “medical-staff” measure based on a formal diagnosis by a health professional. Alternatively, a “self-reported” measure could be based on symptoms reported periodically by the subjects.

In addition, as indicated by computer 323, along the lines of the search engine technique previously described in the background section, the search queries of the friends in the friend sample could be monitored. With this arrangement, the number of occurrences of the particular infection or adoption related search queries used in the prior art technique and appearing in the friend search queries are used in place of the number of staff diagnoses or individuals with self-reported symptoms or adoption trends. As previously mentioned, since the search results are essentially immediately available, this latter technique can provide estimates with further increased lead times. This alternative is particularly advantageous when used in connection with the communication monitoring technique previously discussed in connection with friend relationship determination. Specifically, many search engine companies, such as Google, also offer email and other communications alternatives. Consequently, they have access to the communications data that can be used to establish friend relationships. Therefore, in these cases, the entire method could be run completely under machine control.

In step 208, the infection/adoption information is stored, for example, in database 324 as indicated schematically by arrow 322. Next, in step 210 and as indicated schematically by arrow 326, the stored information is used to create and update a model 328 that reflects the epidemic or trend which is to be predicted. Generally, this model would be based on equations (1) and (2) set forth above. The coefficients in the equations are determined by fitting the infection/adoption data to the equation using conventional non-linear least squares estimation procedures.

Once the model has been determined, it may be used to predict future infections or adoptions. For example, in step 212, the infection/adoption rate as determined by equation (2) set forth above could be compared to a predetermined rate threshold 336 as schematically illustrated by arrows 330 and 334 and comparator 332. If as determined in step 214, that this threshold has been reached, then an epidemic or adoption could be declared as indicated schematically by arrow 338 and the process finishes in step 216.

Alternatively, if in step 214, it is determined that the predetermined threshold has not been reached, then the process returns to step 206. In this manner new infection/adoption data can be obtained and the model updated to reflect the current situation. For example, the model could be updated periodically, such as daily or weekly.

As an example, to evaluate the effectiveness of exploiting nominated friends as social network sensors, the spread of an influenza virus among students attending Harvard College in 2009 was used as a test case. In the fall of 2009, both seasonal influenza (which typically kills 41,000 Americans each year) and the H1N1 influenza strain were prevalent in the United States, though the great majority of cases in 2009 have been attributed to the latter. It is estimated that the H1N1 influenza epidemic, which began roughly in April 2009, infected over fifty million Americans. Unlike seasonal influenza, which typically affects individuals older than sixty-five, H1N1 tends to affect young people. Nationally, according to the Center for Disease Control (CDC), the epidemic peaked in late October 2009, and vaccination only became widely available in December 2009.

In the example case two groups of students were empanelled: a “random” sample (N=319) and a “friend” sample (N=425) composed of individuals who were nominated as a friend at least once by a member of the random sample. After giving informed consent, all subjects completed a brief on-line background questionnaire soliciting demographic information, influenza and vaccination status since Sep. 1, 2009, and certain self-reported measures of popularity. Basic administrative data, such as sex, class of enrolment, and information about participation in varsity sports, was also obtained from the Harvard College registrar.

The influenza outcomes were studied in these two samples from September 1 to Dec. 31, 2009 using two different measures. A “medical-staff” measure was based on a formal diagnosis by a health professional and typically reflected more severe symptoms. This involved tracking cases of formally diagnosed influenza among the students in the samples as recorded by University Health Services (UHS) beginning on Sep. 1, 2009 through Dec. 31, 2009. Presenting oneself to the health service indicates a more severe level of symptomatology, of course, and so the same overall prevalence using this diagnostic standard would be expected to differ from self-reported influenza discussed below. However, UHS data offered the advantage of obtaining information about influenza symptoms as assessed by medical staff. Eighty-four percent of the students who agreed to participate in the survey portion of the study also gave written permission to release their health records. Finally, seven students reported being diagnosed with influenza by medical staff at facilities other than UHS (in response to survey questions asked of all students), so these students were included in the data as well.

The second “self-reported” measure was based on symptoms reported biweekly by subjects, and it captured cases that did not necessarily come to formal medical attention. Beginning on Oct. 23, 2009, self-reported influenza symptom information was collected from participants via email twice weekly (on Mondays and Thursdays), continuing until Dec. 31, 2009. The enrolled students were queried about whether they had had a fever or influenza symptoms since the last email contact. Students were deemed to have a case of influenza (whether seasonal or the H1N1 variety) if they report having a fever of greater than 100° F. (37.8° C.) and at least two of the following symptoms: sore throat; cough; stuffy or runny nose; body aches; headache; chills; or fatigue.

An assumption was made that cases of influenza do not meaningfully alter the social networks and friendship patterns of Harvard undergraduates, especially over a two-month period. It is also assumed that the friendship network of Harvard students in our sample did not change meaningfully over the period September to December. That is, we treat the network as static over this time interval.

By Dec. 31, 2009, the cumulative incidence of influenza in the samples was eight percent based on diagnoses by medical staff, and thirty-two percent based on self-reports, which mirrored national estimates for this population. The association of several demographic and other variables with cumulative influenza incidence at day 122 (the last day of follow-up) was studied to determine whether they predicted an increase in overall risk. None of these variables was significantly associated with influenza diagnoses by medical staff, so the study focused on the effect of these variables on shifts in the timing of the distribution. This involved fitting the cumulative distribution of influenza outcomes to the cumulative logistic functions in equations (1) and (2) above using a nonlinear least squares (NLS) estimation procedure. A Gauss-Newton estimation procedure was found to be suitable. Such a procedure is disclosed in detail in a publication entitled Nonlinear Regression Analysis and Its Application, Bates D. M. and Watts D. G. (New York: Wiley, 1988). To estimate standard errors and 95% confidence intervals, a bootstrapping procedure was used in which subject observations are repeatedly re-sampled with replacement and the fit is re-estimated.

In this procedure, for medical diagnoses by staff, we assume Pᵢₜ in equation (1) is 1 when subjects have had the influenza on any day up to and including t and 0 otherwise. For self-reported influenza symptoms in some cases information was only available about the interval from t₀ to t₁ in which symptoms occurred, so it was assumed that Pᵢₜ increases uniformly in the interval, i.e. Pᵢₜ=(t−t₀)/(t₁−t₀).

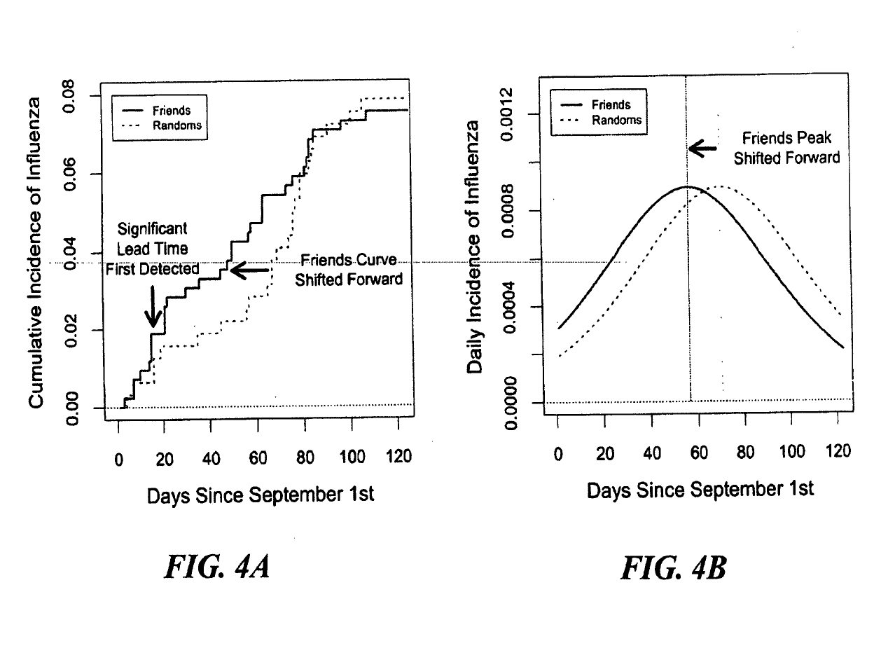

It was found that the cumulative incidence curves for the friend sample and the random sample diverge and then converge as shown in FIGS. 4A and 4B. In the FIG. 4A, a nonparametric maximum likelihood estimate (NPMLE) of cumulative influenza incidence (based on diagnoses by medical staff) shows that individuals in the friend sample tended to get infected with the influenza virus earlier than individuals in the random sample. Moreover, predicted daily incidence from a nonlinear least squares fit of the data to a logistic distribution function suggests that the peak incidence of influenza is shifted forward in time for the friends sample by 13.9 days as shown in FIG. 4B (95% C.I. 9.9-16.6). A significant (p<0.05) lead time for the friend sample was first detected with data available up to Day 16, providing significant early warning of this epidemic in this population. This represents approximately 60% of one standard deviation in the time to event in the whole sample. The results also suggest a significant but smaller shift in self-reported influenza symptoms (3.2 days, 95% C.I. 2.2-4.3). In both cases, the estimates are robust to a number of control variables including H1N1 vaccination, seasonal influenza vaccination, sex, college class, and varsity sports participation.

Further, the subjects' self-perceptions of popularity were surveyed using an eight-item scale, but in this example, this measure did not yield a significant shift forward in time for influenza diagnoses by medical staff. Moreover, controlling for self-reported popularity did not alter the significance of the lead time provided by the friend sample for either influenza diagnoses by medical staff or self-reported influenza symptoms. Being nominated as a friend captures more network information (e.g., the tendency to be central in the network) than self-reported network attributes.

The foregoing estimates rely on full information ex post, however, it was also determined that it is possible to detect a difference in the friend sample and the random sample in real time, given less complete data. This was done by estimating the models each day using all available information up to that day. For influenza diagnoses by medical staff, the friend sample showed a significant lead time (p<0.05) on day 16, a full 46 days before the estimated peak in daily incidence in visits to the health service. For self-reported influenza symptoms, the friend sample showed a significant lead time by day 39, which is 83 days prior to the estimated peak in daily incidence in self-reported symptoms.

Although the inventive method does not require information about the full network, the survey took place on a college campus in which many nominators were themselves nominated, and the same person was frequently nominated several times. As a result, a connected component of 714 people emerged out of the 1,789 unique individuals who were either surveyed or identified as friends by those who took part in the survey. In order to visualize the network an algorithm called Pajek (Batagelj V. and Mrvar A. (2006) PAJEK: Program for Analysis and Visualization of Large Networks, version 1.14 was used to draw pictures of the networks and another algorithm, which generates a matrix of shortest network path distances from each node to all other nodes in the network and repositions nodes was used to reduce the sum of the difference between the plotted distances and the network distances (Kamada T, Kawai C (1989) An algorithm for drawing general undirected graphs. Information Processing Letters 31:113-120).

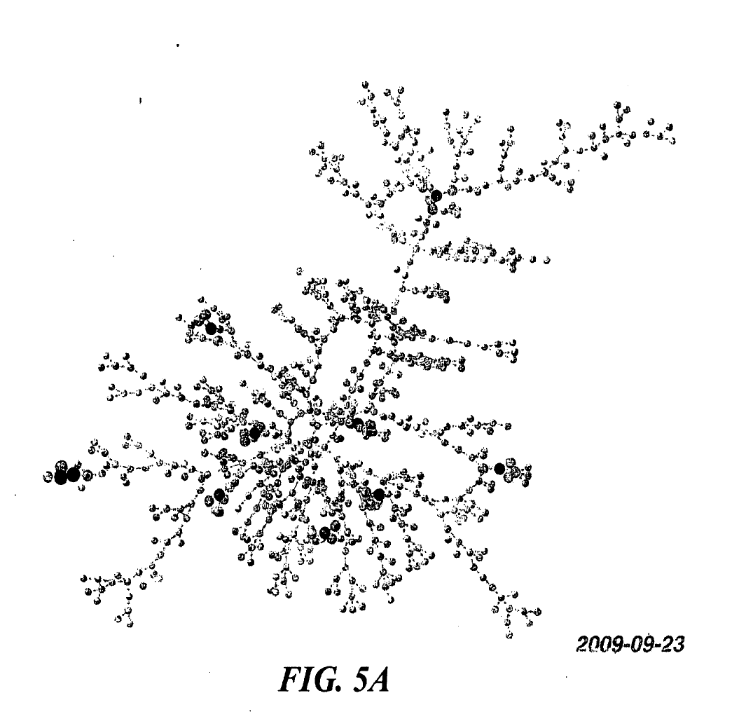

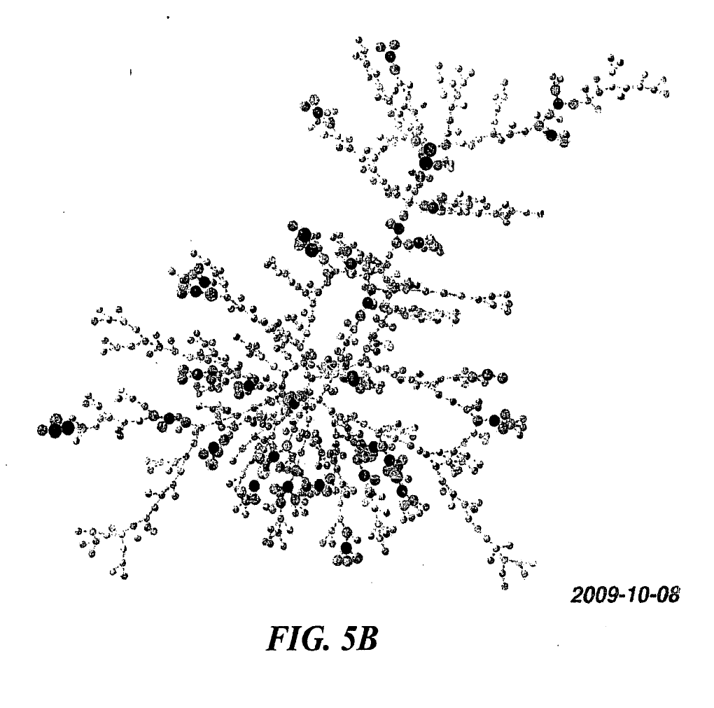

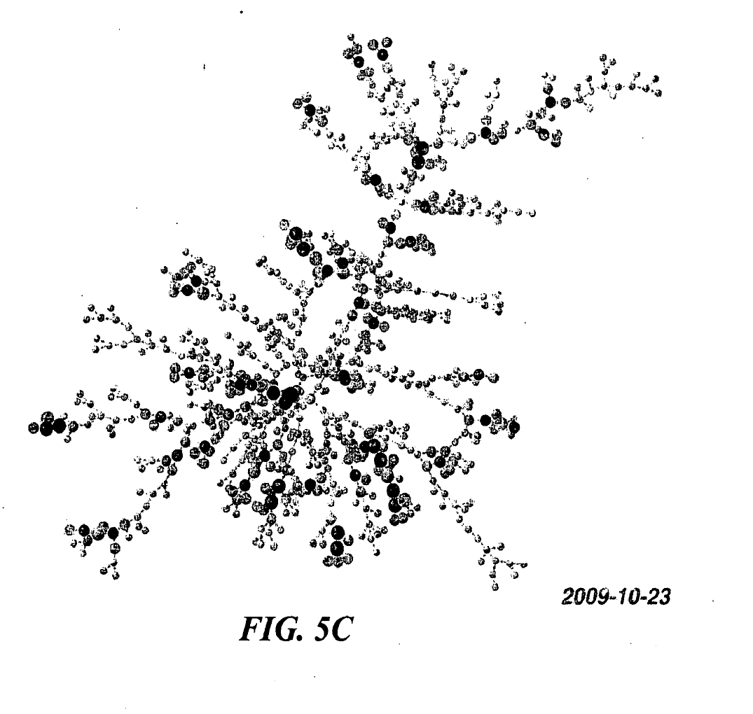

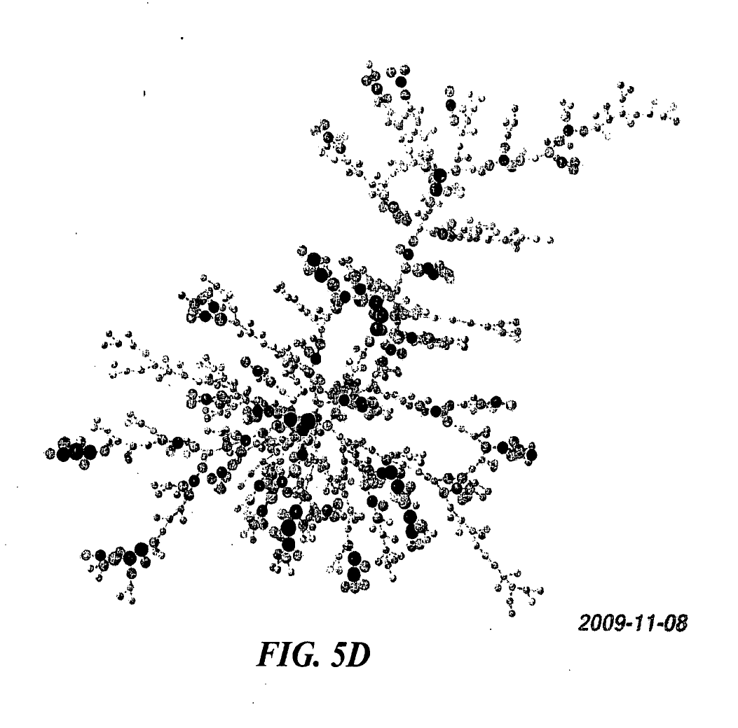

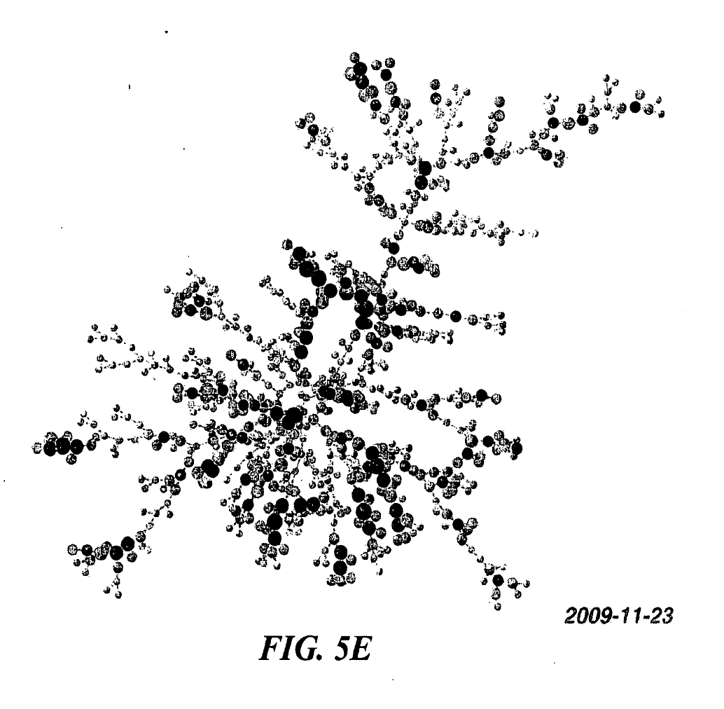

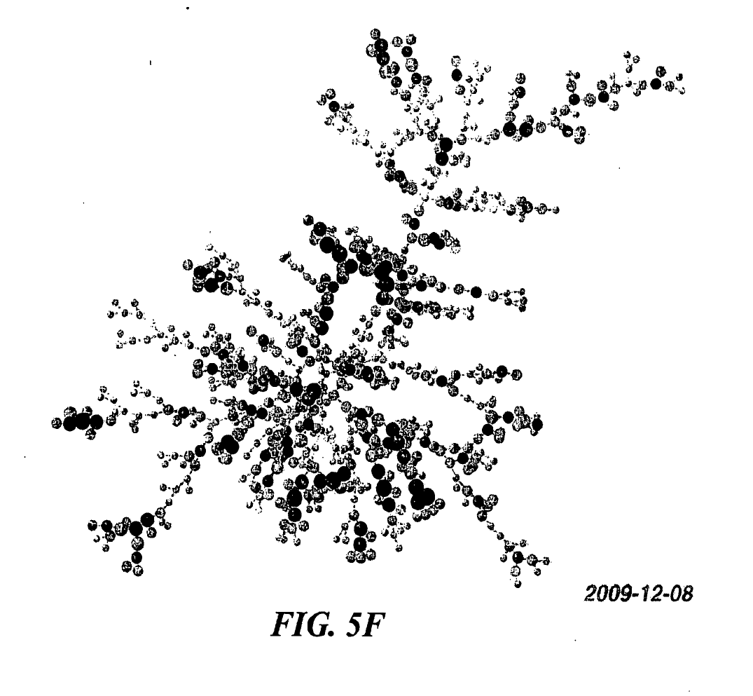

The spread of influenza in this network is illustrated in FIGS. 5A-5F. Each figure shows the largest component of the network (714 people) for a specific date, with each line representing a friendship nomination and each node representing a person. Infected individuals are black, friends of infected individuals are gray, and node size is proportional to the number of friends infected. All available information regarding infections is used here. These figures illustrate the tendency of the influenza virus to “bloom” in more central nodes of the network.

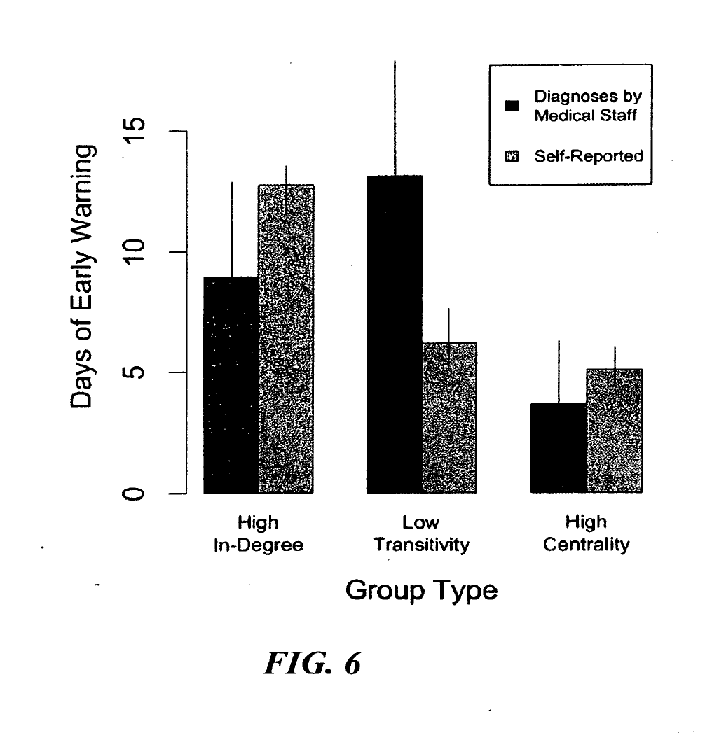

Sampling a densely interconnected population also allowed egocentric network properties like in-degree (number of times a subject was nominated as a friend), betweenness centrality (the number of shortest paths in the network that pass through an individual), and transitivity (the probability that two of one's friends are friends with one another) to be measured. The results showed that the friend sample differed significantly from the random sample for all these measures, exhibiting higher in-degree (Mann Whitney U test p<0.001) and centrality (p<0.001), and lower transitivity (p=0.039). Consequently, each of these measures could be used to identify groups that could be utilized as social network sensors when full network information is, indeed, available as shown in FIG. 6.

For example, in-degree can be expected to be associated with early contagion because having more friends means more paths to others in the network who might be infected. NLS estimates suggest that each additional nomination shifts the influenza curve left by 5.6 days (95% C.I. 3.6-8.1) for influenza diagnoses by medical staff and 8.0 days (95% C.I. 7.3-8.5) for self-reported symptoms. Interestingly, the same is not true for out-degree (the number of friends a person names) though there is low variance in this measure since most people named three friends in this example.

Betweenness centrality can also be expected to be associated with early contagion. NLS estimates suggest that individuals with maximum observed centrality shift the influenza curve left by 16.5 days (95% C.I. 1.9-28.3) for influenza diagnoses by medical staff and 22.9 days (95% C.I. 20.0-27.2) for self-reported symptoms relative to those with minimum centrality. Moreover, centrality remains significant even when controlling for both in-degree and out-degree, suggesting that it is not just the number of friends that is important, but also the number of friends of friends, friends of friends of friends, and so on.

Finally, transitivity can be expected to be negatively associated with early contagion. People with high transitivity may be poorly connected to the rest of the network because their friends tend to know one another and exist in a tightly-knit group. In contrast, those with low transitivity tend to be connected to many different, independent groups, and each additional group increases the possibility that someone in that group has the influenza and it spreads to the subject. NLS estimates suggest that individuals with minimum observed centrality shift the influenza curve left by 31.9 days (95% C.I. 23.5-43.5) for influenza diagnoses by medical staff and 15.0 days (95% C.I. 12.7-18.5) for self-reported symptoms compared to those with maximum transitivity. Moreover, transitivity remains significant even when controlling for both in-degree and out-degree.

For influenza, and for many other contagious diseases, early knowledge of when—or whether—an epidemic is unfolding is crucial to policy makers and public health officials responsible for defined populations, whether small or large. In fact, models assessing the impact of prophylactic vaccination in a metropolis such as New York City suggest that vaccinating even one third of the population would save lives and shorten the course of the epidemic, but only if implemented a month earlier than usual.

The inventive method could be used to monitor targeted populations regardless of their size, in real time. For example, a health service at a university (or other institution) could impanel a sample of students who are nominated as friends and who agree to be passively monitored for their health care use; a spike in cases in this group could be read as a warning of an impending outbreak. Public health officials responsible for a city could impanel a sample of randomly chosen individuals and a sample of nominated friends (perhaps a thousand people in all) who have agreed to report their symptoms using brief, periodic text messages or an online survey system (like the one employed here). Similarly, national or country-wide officials or insurers could impanel a sample of randomly chosen individuals and a sample of nominated friends and then use emergency room visits of these people as an indicator of an epidemic or trend.

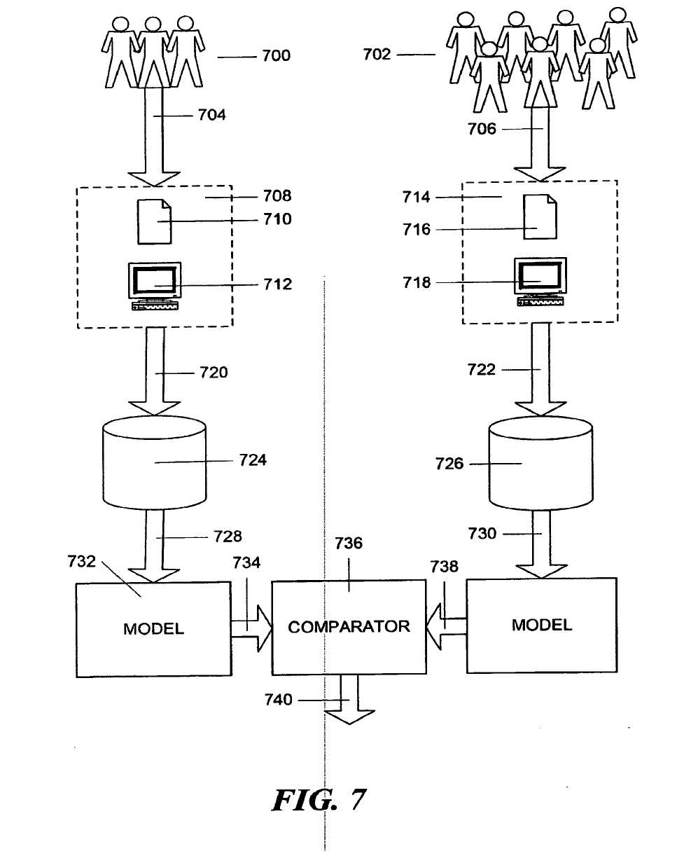

The differing behavior of the friend and random samples could be exploited in at least two different ways. First, if solely the friends sample were being followed, an analyst tracking an outbreak might look for the first evidence that the incidence of the pathogen among the friends rose above a predetermined rate as illustrated in FIG. 3. Second, in a strategy that would yield more information, the analyst could track both a sample of friends and a sample of random subjects, and the harbinger of an epidemic could be taken to be when the two curves were seen to first diverge from each other. This process is illustrated in FIG. 7.

The randomly selected sample 700 and the friend sample 702 are both treated similarly. In particular, the individuals in the random sample 700 are checked for an infection or the adoption of a trend as indicated by arrow 704 and box 708 and individuals in the friend sample 700 are checked for an infection or the adoption of a trend as indicated by arrow 706 and box 714. As previously described, these checks could be performed in several different ways. For example, in the case of infections, as indicated schematically by papers 710 and 716, this check could be a “medical-staff” measure based on a formal diagnosis by a health professional or a “self-reported” measure could be based on symptoms reported periodically by the individuals. Alternatively, as indicated by computers 712 and 718, the search queries of the individuals in the random sample and the friend sample could be monitored. Other passive behavior monitors could also be used where sufficient information is available. These might include purchasing behaviors, such as purchasing a particular book or class of books where the information is available from on-line purchases and health care use.

The infection/adoption information for each sample is then stored, for example, for the random sample 700 in database 724 as indicated schematically by arrow 720 and for the friend sample 702 in database 726 as indicated schematically by arrow 722. Next, as indicated schematically by arrows 728 and 730, the stored information is used to create and update models 732 and 740 that reflect the epidemic or trend which is to be predicted. The outputs of models 732 and 740, represented by arrows 734 and 738, respectively are provided to a comparator schematically illustrated as comparator 736 which tracks the differences in the model outputs and generates and output 742 when the models diverge sufficiently.

Especially in the case of the spread of contagions other than biological pathogens, the difference between these two curves provides additional information: the adoption curve among the random sample provides evidence of secular trends, whereas the difference between the two curves provides evidence of a network effect, over and above the baseline force of the epidemic.

It is noteworthy that, in the specific case of the influenza, the inventive method appears to provide longer lead times than other extant methods of monitoring influenza epidemics. Current surveillance methods for the influenza, such as those implemented by the CDC, require collection of data from subjects seeking outpatient care or having lab tests, and are typically lagging indicators about the timing of the epidemic (it is, at best, one to two weeks behind the actual course).

How much advance warning would be achieved for other pathogens or in populations of larger size or different composition remains unknown. The ability of the proposed method to detect outbreaks early, and how early it might do so, will depend on intrinsic properties of the thing that is spreading (e.g., the biology of the pathogen, the nature of the product, idea or fashion, etc.), the overall prevalence of susceptible or affected individuals, the number of people impaneled into the sensor group, the topology of the network, and other factors, such as whether the outbreak modifies the structure of the network as it spreads (for example, by killing people in the network, or, in the case of spreading information, perhaps by affecting the tendency of any two individuals to remain connected after the information is transmitted).

While the social network sensor strategy described here has been illustrated with a particular outbreak (influenza) in a particular population (college students), it could in principle be generalized to many contagions that spread in networks, whether biological (germs), commercial (product adoption), psychological (depression), normative (altruism), informational (rumors), or behavioral (smoking). Outbreaks of deleterious or desirable conditions could be detected before they have reached a critical threshold in populations of interest. In principle, anything that spreads via a network, such as attitudes towards products, expectations about the end of a recession, attitudes towards politicians, etc. can be forecast with the inventive method. Things that do not spread via a network, such as whether one buys tires for one's car, etc. would not be forecast by this invention.

What is claimed is:

1. A method for anticipating that infection by a disease will reach epidemic levels in a population having a plurality of individuals who interact and spread the disease, the method comprising:
(a) randomly selecting individuals from the population;
(b) determining friends of the selected individuals;
(c) monitoring the friends determined in step (b) for contraction of the disease and determining a number of friends contracting the disease; and
(d) based on the determined number and the timing of the monitoring that takes place in step (c), determining that infection by the disease will reach epidemic levels in the entire population.

2. The method of claim 1 wherein step (b) comprises asking each selected individual to nominate at least one friend and selecting as friends individuals from the population who were nominated as a friend by at least one selected individual.

3. The method of claim 2 wherein step (b) comprises selecting as friends individuals from the population who were nominated as a friend by a plurality of selected individuals.

4. The method of claim 1 wherein step (b) comprises asking each selected individual to identify at least one friend.

5. The method of claim 1 wherein step (b) comprises monitoring communications of each selected individual with other people and determining as friends people with whom each selected individual has had a predetermined number of communications.

6. The method of claim 1 wherein step (c) is conducted periodically.

7. The method of claim 1 wherein step (c) comprises monitoring each friend with external means for evidence of infection.

8. The method of claim 1 wherein in step (c) each friend self reports an infection.

9. The method of claim 1 wherein step (d) comprising determining whether the number and timing of friends contracting the disease follows a predetermined pattern.

10. The method of claim 1 wherein step (d) comprises determining when the number reaches a predetermined threshold.

11. The method of claim 1 wherein step (d) comprises determining when the rate of infection reaches a predetermined threshold.

12. The method of claim 1 wherein step (d) comprises monitoring a random sample of the population to determine a number of random individuals infected by the disease and comparing the number of infected friends to the number of infected random individuals.

13. The method of claim 12 wherein step (d) comprises determining that infection by the disease will reach epidemic levels in the entire population when the number of infected friends and the number of infected random individuals diverges by a predetermined amount.

14. The method of claim 1 wherein the individuals form a human social network and wherein step (d) comprises monitoring the number of infected friends and characteristics of the network.

15. The method of claim 14 wherein the characteristics of the network comprise one of the group consisting of in-degree, betweenness centrality and transitivity.

16. The method of claim 1 wherein step (c) comprises monitoring the online search engine queries of the friends determined in step (b) for occurrences of selected search queries and determining a number of such occurrences.

17. The method of claim 16 wherein step (d) comprising determining whether the number and timing of the selected search queries follows a predetermined pattern.

18. The method of claim 16 wherein step (d) comprises determining when the rate of searches using the selected search queries reaches a predetermined threshold.

19. The method of claim 16 wherein step (d) comprises monitoring a random sample of the population to determine a number of random individuals performing searches using the selected search queries and comparing the number of friends performing searches using the selected search queries to the number of random individuals using the selected search queries.

20. The method of claim 19 wherein step (d) comprises determining that infection by the disease will reach epidemic levels in the entire population when the number of friends performing searches using the selected search queries and the number of random individuals performing searches using the selected search queries diverges by a predetermined amount.

21. A method for anticipating that adoption of a trend will reach pre-determined levels in a population having a plurality of individuals who interact and influence the adoption, the method comprising:
(a) randomly selecting individuals from the population;
(b) determining friends of the selected individuals;
(c) monitoring the friends determined in step (b) for adoption of the trend to determine a number of friends who have adopted the trend; and
(d) based on the determined number and the timing of the monitoring that takes place in step (c), determining that adoption of the trend will reach pre-determined levels in the entire population.

22. The method of claim 21 wherein step (b) comprises asking each selected individual to nominate at least one friend and selecting as friends individuals from the population who were nominated as a friend by at least one selected individual.

23. The method of claim 21 wherein step (b) comprises selecting as friends individuals from the population who were nominated as a friend by a plurality of selected individuals.

24. The method of claim 21 wherein step (b) comprises asking each selected individual to identify at least one friend.

25. The method of claim 21 wherein step (b) comprises monitoring communications of each selected individual with other people and determining as friends people with whom each selected individual has had a predetermined number of communications.

26. The method of claim 21 wherein step (c) is conducted periodically.

27. The method of claim 21 wherein step (c) comprises monitoring each friend with external means for adoption of the trend.

28. The method of claim 21 wherein in step (c) each friend self reports an adoption.

29. The method of claim 21 wherein step (d) comprising determining whether the number and timing of friends adopting the trend follows a predetermined pattern.

30. The method of claim 21 wherein step (d) comprises determining when the number reaches a predetermined threshold.

31. The method of claim 21 wherein step (d) comprises determining when the rate of adoption reaches a predetermined threshold.

32. The method of claim 21 wherein step (d) comprises monitoring a random sample of the population to determine a number of random individuals that have adopted the trend and comparing the number of adopting friends to the number of adopting random individuals.

33. The method of claim 32 wherein step (d) comprises determining that adoption of the trend will reach predetermined levels in the entire population when the number of adopting friends and the number of adopting random individuals diverges by a predetermined amount.

34. The method of claim 21 wherein the individuals form a human social network and wherein step (d) comprises monitoring the number of adopting friends and characteristics of the network.

35. The method of claim 34 wherein the characteristics of the network comprise one of the group consisting of in-degree, betweenness centrality and transitivity.

36. The method of claim 21 wherein step (b) comprises monitoring communications of each selected individual with other people and determining as friends people with whom each selected individual has had a predetermined number of communications.

37. The method of claim 36 wherein step (d) comprising determining whether the number and timing of selected search query occurrences follows a predetermined pattern.

38. The method of claim 36 wherein step (d) comprises determining when the number of occurrences reaches a predetermined threshold.

39. The method of claim 36 wherein step (d) comprises determining when the rate of occurrences reaches a predetermined threshold.

40. The method of claim 36 wherein step (d) comprises monitoring a random sample of the population to determine a number of random individuals that have performed searches using the selected search queries and comparing the number of friends who have performed searches using the selected search queries to the number of random individuals who have performed searches using the selected search queries.

41. The method of claim 40 wherein step (d) comprises determining that adoption of the trend will reach predetermined levels in the entire population when the number of friends who have performed searches using the selected search queries and the number of random individuals who have performed searches using the selected search queries diverges by a predetermined amount.

42. The method of claim 36 wherein the individuals form a human social network and wherein step (d) comprises monitoring the number of friends who have performed searches using the selected search queries and characteristics of the network.
